(19) United States
(12) Patent Application Publication
(10) Pub. No.: US 2019/0379255 A1
(43) Pub. Date: Dec. 12, 2019

(54) MOTOR AND DISK DRIVE DEVICE

(71) Applicant: Nidec Corporation, Kyoto (JP)

(72) Inventors: Daisuke MORO, Kyoto (JP); Tomohiro YONEDA, Kyoto (JP); Hiroshi KOBAYASHI, Kyoto (JP); Masayuki MAEDA, Kyoto (JP)

(21) Appl. No.: 16/432,217

(22) Filed: Jun. 5, 2019

(30) Foreign Application Priority Data
Jun. 12, 2018 (JP) 2018-111721

(51) Int. Cl. H02K 5/167; H02K 7/08; H02K 21/22; G11B 19/20; F16C 17/02; F16C 33/10

(52) U.S. Cl. CPC H02K 5/1677; H02K 7/088; H02K 21/22; F16C 2380/26; F16C 17/026; F16C 33/107; G11B 19/2036

(57) ABSTRACT

A motor includes a shaft along a central axis, an inner ring fixed on an outer circumferential surface of the shaft, a tubular sleeve extending axially around the shaft, an outer ring fixed to an inner circumferential surface of the sleeve via an adhesive agent, a cap annularly expanding around the shaft and covering an axially upper side of the inner and outer rings, and a bearing portion including dynamic pressure grooves in at least one of an outer circumferential surface of the inner ring and the inner circumferential surface of the sleeve. In the bearing portion, a stationary portion and a rotating portion face each other across a gap where lubricating oil is present. At least one interface of the lubricating oil is in a radial gap between the inner and outer rings. The cap includes a recess recessed axially downward over an entire circumference. At least a portion of an outer circumferential surface of the recess portion is fixed by press-fitting to an inner circumferential surface of the sleeve.

### CROSS REFERENCE TO RELATED APPLICATION

This application claims the benefit of priority to Japanese Patent Application No. 2018-111721 filed on Jun. 12, 2018. The entire content of this application are hereby incorporated herein by reference.

### 1. FIELD OF THE DISCLOSURE

The present disclosure relates to a motor and a disk drive device.

### 2. BACKGROUND

Conventionally, a hard disk device or an optical disk device is mounted with a motor for rotating the disk. The motor has a bearing portion between the rotating portion and the stationary portion to perform high-speed rotation. In order to improve the stability and accuracy of the rotation of the disk during high-speed rotation, a technique for improving the accuracy of the member forming the bearing portion is required. A motor having a conventional bearing portion is described in, for example, Japanese Laid-Open Patent Publication No. 2005-54990 and Japanese Laid-Open Patent Publication No. 2012-89200.

A rotary device of Japanese Laid-Open Patent Publication No. 2012-89200 has a bearing unit that includes a radial dynamic pressure groove provided in at least one of an inner circumferential surface of an inner sleeve and an outer circumferential surface of a shaft and a lubricant agent held between the inner sleeve and the shaft. In addition, the rotary device includes a cap member covering the interface of the lubricant agent in order to suppress evaporation of the lubricant agent. After the bearing unit is filled with the lubricant agent, the cap member is coupled to an outer circumferential surface of an outer ring that is indirectly joined to a hub on which a recording disk is placed on an outer circumferential portion.

A fluid dynamic bearing system of Japanese Laid-Open Patent Publication No. 2005-54990 includes a shield and a fluid trap portion. The shield is laser welded to a bearing sleeve, for example, and covers the opening face of the bearing sleeve. The shield prevents lubricating oil that is included in a bearing gap and is about to rise to the opening surface of the bearing sleeve from scattering onto a magnetic disk. An oil filling hole for pouring lubricating oil is provided on the shield. The fluid trap portion is press-fitted or fitted into a recess at the upper end portion of the bearing member. The fluid trap portion traps lubricating oil rising on the surface of the shaft, thereby preventing the lubricating oil from scattering. Further, the fluid trap portion includes a notch portion for passing the lubricating oil.

However, in the rotary device disclosed in Japanese Laid-Open Patent Publication No. 2012-89200, the cap member is coupled to the outer circumferential surface of the outer ring, thereby generating in the outer ring a stress directed inward. This may cause the hub indirectly joined to the outer ring to be eccentric or inclined relative to the bearing unit. As a result, the rotation of the recording disk placed on the outer circumferential portion of the hub may become unstable.

Further, in the fluid dynamic bearing system disclosed in Japanese Laid-Open Patent Publication No. 2005-54990, in order to accurately pour the lubricating oil into the bearing gap, at the time of manufacture, it is necessary to axially align the oil filling hole of the shield and the notch portion of the fluid trap portion and to perform an operation of circumferentially positioning the pouring nozzle and the oil filling hole. For this reason, the working efficiency may decrease and the manufacturing cost may increase.

### SUMMARY

Example embodiments of the present disclosure provide motors each configured so that lubricating oil is able to be easily poured into a bearing portion such that eccentricity or inclination of a member rotating via the bearing portion is reduced or prevented in a state where a cap covering an interface of the lubricating oil is attached.

According to a first example embodiment of the present disclosure, a motor includes a stationary portion including a stator, and a rotating portion rotatably supported via a bearing portion about a vertically extending central axis with respect to the stationary portion, a shaft disposed along the central axis, an inner ring fixed on an outer circumferential surface of the shaft, a sleeve extending axially in a tubular shape around the shaft, an outer ring fixed to an inner circumferential surface of the sleeve via an adhesive agent, a cap annularly expanding around the shaft and covering an axially upper side of the inner ring and the outer ring, and the bearing portion including a plurality of dynamic pressure grooves in at least one of an outer circumferential surface of the inner ring and the inner circumferential surface of the sleeve, wherein in the bearing portion, the stationary portion and the rotating portion face each other across a gap where lubricating oil is present, at least one of interfaces of the lubricating oil is positioned in a radial gap between the inner ring and the outer ring, the cap includes a recess portion recessed axially downward over an entire circumference, and at least a portion of an outer circumferential surface of the recess portion is fixed by press-fitting to the inner circumferential surface of the sleeve.

According to the first example embodiment of the present disclosure, lubricating oil is able to be poured highly accurately and easily from a radial gap between the inner ring and the outer ring. The recess portion of the cap radially bends in a state where the cap covering the upper side of the interface of the lubricating oil is press-fitted. This reduces or prevents stress generated in the sleeve rotating via the bearing portion and reduces or prevents eccentricity or inclination.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal sectional view of a disk drive device according to a first example embodiment of the present disclosure.

FIG. 2 is a longitudinal sectional view of the motor according to the first example embodiment of the present disclosure.

FIG. 3 is a partial longitudinal sectional view of the motor according to the first example embodiment of the present disclosure.

FIG. 4 is a partial longitudinal sectional view of the motor according to the first example embodiment of the present disclosure.

FIG. 5 is a perspective view of a first cap according to the first example embodiment of the present disclosure.

FIG. 6 is a partial longitudinal sectional view of the motor according to a modification of an example embodiment of the present disclosure.

FIG. 7 is a partial longitudinal sectional view of the motor according to a modification of an example embodiment of the present disclosure.

FIG. 8 is a partial longitudinal sectional view of the motor according to a modification of an example embodiment of the present disclosure.

FIG. 9 is a partial longitudinal sectional view of the motor according to a modification of an example embodiment of the present disclosure.

FIG. 10 is a partial longitudinal sectional view of the motor according to a modification of an example embodiment of the present disclosure.

FIG. 11 is a partial longitudinal sectional view of the motor according to a modification of an example embodiment of the present disclosure.

### DETAILED DESCRIPTION

Hereinafter, example embodiments of the present disclosure will be described with reference to the drawings. Meanwhile, in the present application, a direction parallel to a central axis of a motor is referred to as “axial direction”, “axial”, or “axially”, a direction orthogonal to the central axis of the motor is referred to as “radial direction”, “radial”, or “radially”, and a direction along a circular arc having a center on the central axis of the motor is referred to as “circumferential direction”, “circumferential”, or “circumferentially”. In addition, in the present application, the shape or the positional relationship of each component will be described on the basis of the axial direction being the vertical direction and, with respect to an inner ring and an outer ring, the cap side being the upper side. However, it is not intended that this definition of the vertical direction limits the orientation in use of a motor and a disk drive device according to the present disclosure. In addition, a “parallel direction” in the present application includes a substantially parallel direction. In addition, an “orthogonal direction” in the present application includes a substantially orthogonal direction.

### 1. First Example Embodiment

### 1-1. Configuration of Disk Drive Device

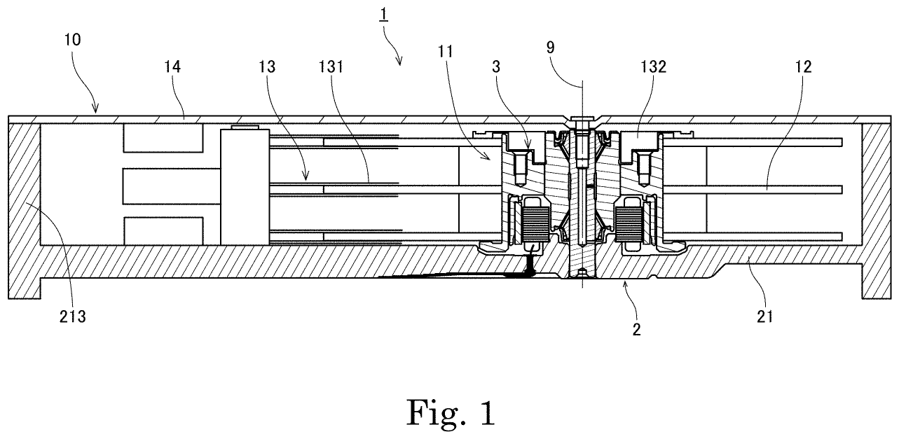

FIG. 1 is a longitudinal sectional view of a disk drive device 1 according to the first example embodiment. The disk drive device 1 is a device that reads and writes information from and to a magnetic disk 12 that has a circular hole at a center while rotating the magnetic disk 12. As shown in FIG. 1, the disk drive device 1 has a motor 11, three magnetic disks 12, an access portion 13, and a cover 14 that constitutes a part of a casing 10.

While supporting the magnetic disk 12, the motor 11 rotates the magnetic disk 12 about a vertically extending central axis 9. The motor 11 has a base portion 21. A part of the base portion 21 radially expands under the magnetic disk 12. A rotating portion 3 of the motor 11, the magnetic disk 12, and the access portion 13 are accommodated in the casing 10 constituted by the base portion 21 and the cover 14. The access portion 13 moves heads 131 along recording surfaces of the magnetic disk 12 to at least one of read and write information from and to the magnetic disk 12. Note that the disk drive device 1 may have the magnetic disk 12 with one, two, or more than three.

An inner space of the casing 10 is filled with clean air having extremely little dust. As a result, the resistance of the gas against the access portion 13 is reduced. In place of air, however, helium gas, hydrogen gas, or nitrogen gas may be filled. Alternatively, a gas mixture of any of these gases and air may be filled. A junction between the base portion 21 and the cover 14 is sealed with a sealant such as elastomer. Thus, the inner space of the casing 10 is kept airtight.

### 1-2. Configuration of Motor

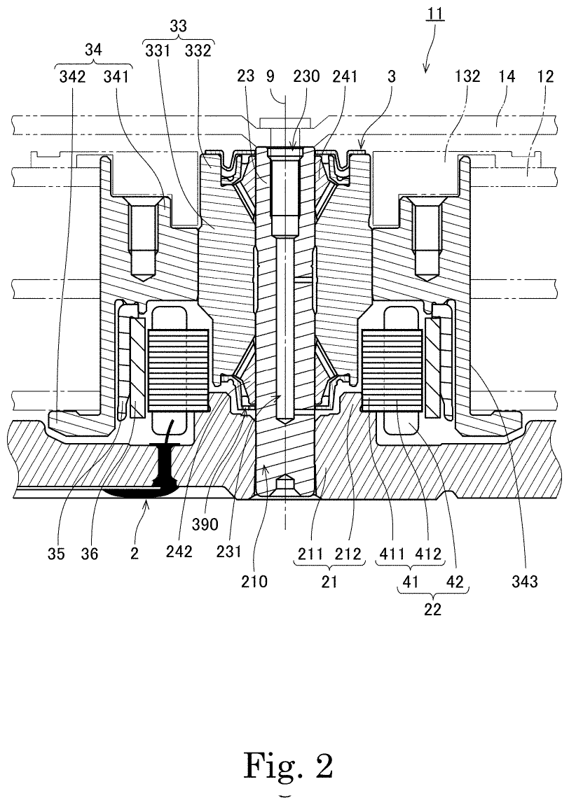

Subsequently, a more detailed configuration of the motor 11 will be described. FIG. 2 is a longitudinal sectional view of the motor 11 according to the first example embodiment. As shown in FIG. 2, the motor 11 has a stationary portion 2, the rotating portion 3, and a bearing portion to be described later. The stationary portion 2 is relatively stationary with respect to the casing 10 of the disk drive device 1. The rotating portion 3 is rotatably supported via the bearing portion about a central axis 9 with respect to the stationary portion 2.

The stationary portion 2 of the present example embodiment has the base portion 21, a stator 22, a shaft 23, a first inner ring 241, and a second inner ring 242.

The base portion 21 supports the stator 22. As the material of the base portion 21, for example, a metal such as aluminum alloy or stainless steel is used. The base portion 21 has a base bottom plate portion 211, a base cylindrical portion 212, and a base side wall portion 213 (see FIG. 1). The base bottom plate portion 211, the base cylindrical portion 212, and the base side wall portion 213 are formed integrally.

The base bottom plate portion 211 expands perpendicularly to the central axis 9 below the rotating portion 3 and the magnetic disk 12 which will be described later. A circuit board for supplying a drive current to the motor 11 is disposed on a lower surface of the base bottom plate portion 211 of the present example embodiment. The base cylindrical portion 212 extends in a substantially cylindrical shape upward from a part of an upper surface of the base bottom plate portion 211. Further, the base cylindrical portion 212 is disposed substantially coaxially with the central axis 9. The base side wall portion 213 axially extends in the radially outside of the rotating portion 3, the magnetic disk 12, and the access portion 13, to be described later. The upper end portion of the base side wall portion 213 is fixed to the lower surface of the radially outer end portion of the cover 14.

The stator 22 is an armature that includes a stator core 41 and a plurality of coils 42. The stator 22 is positioned above the base bottom plate portion 211 and the radially outside of the base cylindrical portion 212. The stator core 41 is made of, for example, a laminated steel plate in which electromagnetic steel plates such as silicon steel plates are laminated axially. The stator core 41 is directly supported by the base portion 21 by being fixed to the outer circumferential surface of the base cylindrical portion 212 with an adhesive agent, for example. It is to be noted that the stator core 41 may be indirectly supported by the base portion 21 via another member.

The stator core 41 has an annular core back 411 and a plurality of teeth 412 projecting radially outward from the core back 411. The plurality of coils 42 are a collection of conducting wire wound around the plurality of teeth 412. The drive current of the motor 11 is supplied from an external power supply (not illustrated) to the coils 42 via the above-described circuit board and the conducting wire. The plurality of teeth 412 and the plurality of coils 42 are preferably circumferentially arranged about the central axis 9 at substantially equal intervals in an annular shape.

The shaft 23 is a member disposed along the central axis 9 and axially extending on the radially inside of the rotating portion 3 to be described later. A hollow portion 231 is provided around the central axis 9 on the radially inside of the shaft 23. The hollow portion 231 extends axially downward from an opening 230 opening at the upper end portion of the shaft 23. In the upper end portion of the hollow portion 231 including the opening 230, a screw stop hole through which the cover 14 is fixed while being pressed is formed. A part including the lower end portion of the shaft 23 is inserted into a through hole 210 axially penetrating the base bottom plate portion 211 and is fixed with respect to the base bottom plate portion 211. A metal such as stainless steel, for example, is used as the material of the shaft 23.

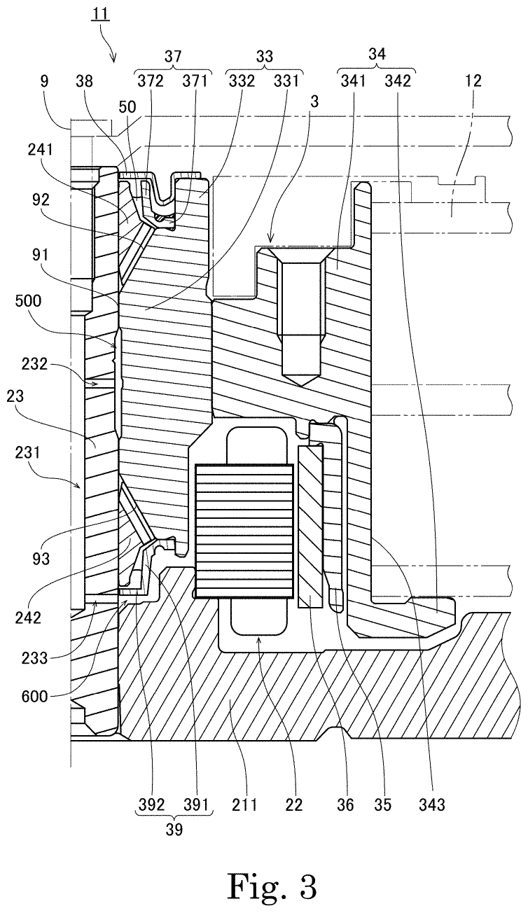

FIG. 3 is a partial longitudinal sectional view of the motor 11 according to the first example embodiment. As shown in FIG. 3, the shaft 23 is provided with a first communication hole 232 and a second communication hole 233. Each of the first communication hole 232 and the second communication hole 233 radially penetrates the shaft 23 in a position axially spaced apart from each other. The first communication hole 232 causes an oil-free space 500 to be described later and the hollow portion 231 to radially communicate. The second communication hole 233 causes the hollow portion 231 and a gap 600 between the lower surface of a second flat plate portion 392 of a second cap 39 to be described later and the upper surface of the base bottom plate portion 211 to radially communicate. It is to be noted that the gap 600 is an unsealed space connected to the external space of the motor 11 via the circumference of the stator 22.

The first inner ring 241 is an annular member fixed to the outer circumferential surface of the upper portion of the shaft 23. The first inner ring 241 projects radially outward over the entire circumference. The second inner ring 242 is an annular member fixed to the outer circumferential surface of the lower portion of the shaft 23. The second inner ring 242 projects radially outward over the entire circumference. The first inner ring 241 and the second inner ring 242 and the shaft 23 are each fixed by press-fitting and with an adhesive agent, for example. However, the first inner ring 241 and the second inner ring 242 and the shaft 23 may be each fixed by press-fitting alone or with an adhesive agent alone, or may be each fixed by another method such as soldering or shrink fitting. Furthermore, the shaft 23 may be a single member with the first inner ring 241 or the second inner ring 242.

The rotating portion 3 of the present example embodiment has a sleeve 33, a hub 34, a yoke 35, a magnet 36, an outer ring 37, a first cap 38, and the second cap 39.

The sleeve 33 is an axially cylindrically extending member around the shaft 23. The sleeve 33 has a sleeve main body 331 and a sleeve projecting portion 332. The sleeve main body 331 axially cylindrically extends around the shaft 23 and is a portion where a lubricating oil 50 is in contact with the inner circumferential surface. The sleeve projecting portion 332 projects upward from the upper portion of the sleeve main body 331 in the radially outside than the outer ring 37 to be described later. The lubricating oil 50 is not in contact with an inner circumferential surface of the sleeve projecting portion 332.

Here, the inner circumferential surface of the sleeve 33 includes an inner circumferential surface 91, an upper inclined surface 92, and a lower inclined surface 93. The inner circumferential surface 91 is an axially extending cylindrical surface. The upper inclined surface 92 is a conical surface (a surface inclined with respect to the axial direction of the upper portion of the sleeve main body 331) that gradually widens in diameter from the upper end portion of the inner circumferential surface 91 towards the upper side. The lower inclined surface 93 is a conical surface (a surface inclined with respect to the axial direction of the lower portion of the sleeve main body 331) that gradually widens in diameter from the lower end portion of the inner circumferential surface 91 towards the lower side.

An outer circumferential surface of the shaft 23 and the inner circumferential surface 91 of the sleeve 33 radially face each other across a slight gap therebetween. The outer circumferential surface of the lower portion of the first inner ring 241 and the upper inclined surface 92 of the sleeve 33 obliquely face each other across a slight gap. The outer circumferential surface of the upper portion of the second inner ring 242 and the lower inclined surface 93 of the sleeve 33 obliquely face each other across a slight gap.

The hub 34 is an annular member positioned in the radially outside of the sleeve 33. As shown in FIG. 3, the hub 34 has a hub annular portion 341 and a flange portion 342. The hub annular portion 341 and the flange portion 342 are formed integrally.

The hub annular portion 341 is a portion radially outwardly expanding around the sleeve 33. The hub annular portion 341 expands annularly about the central axis 9 above the stator 22. The hub annular portion 341 is fixed to the outer circumferential surface of the sleeve main body 331 with an adhesion, for example.

An outer circumferential surface 343 of the hub annular portion 341 fits into a circular hole of the magnetic disk 12. At least a part of the inner circumferential portion of the magnetic disk 12 is in contact with the outer circumferential surface 343 of the hub annular portion 341. Thus, while being radially positioned, the magnetic disk 12 is supported by the rotating portion 3 including the hub annular portion 341.

The flange portion 342 is a portion that radially outwardly expands from the lower end portion of the outer circumferential portion of the hub annular portion 341. The magnetic disk 12 is disposed above the flange portion 342. The lower surface of the bottom magnetic disk 12 is in contact with at least a part of the upper surface of the flange portion 342. As a result, while being axially positioned, the magnetic disk 12 is supported by the rotating portion 3 including the flange portion 342.

The yoke 35 is a cylindrical member that is fixed to the radially outside of the magnet 36 to be described later and holds the magnet 36. An outer circumferential surface of the magnet 36 is fixed to an inner circumferential surface of the yoke 35. The yoke 35 is disposed substantially coaxially with the central axis 9. An upper end portion of the yoke 35 is fixed to a lower portion of the hub annular portion 341 with an adhesive agent or caulking, for example. A ferromagnetic substance such as iron is used as a material of the yoke 35. Thus, it is possible to suppress a magnetic flux generated from the magnet 36 described later from escaping to the outside.

The magnet 36 is fixed to the inner circumferential surface of the yoke 35 with an adhesive agent, for example. An annular permanent magnet is used for the magnet 36 of the present example embodiment. The magnet 36 is positioned in the radially outside of the stator 22. An inner circumferential surface of the magnet 36 radially faces a radially outer end surface of the plurality of teeth 412 of the stator 22 across a slight gap. In addition, the inner circumferential surface of the magnet 36 is magnetized to the N-pole and the S-pole alternately in the circumferential direction. Note that a plurality of magnets may also be used in place of the annular magnet 36. In that case, a plurality of magnets may be disposed on the inner circumferential surface of the yoke 35 so that the magnetic pole face of the N-pole and the magnetic pole face of the S-pole are aligned alternately in the circumferential direction. It is to be noted that the magnet 36 of the present example embodiment is indirectly fixed to the hub 34 via the yoke 35 as described above. However, the magnet 36 may be directly fixed to the hub 34 not via the yoke 35.

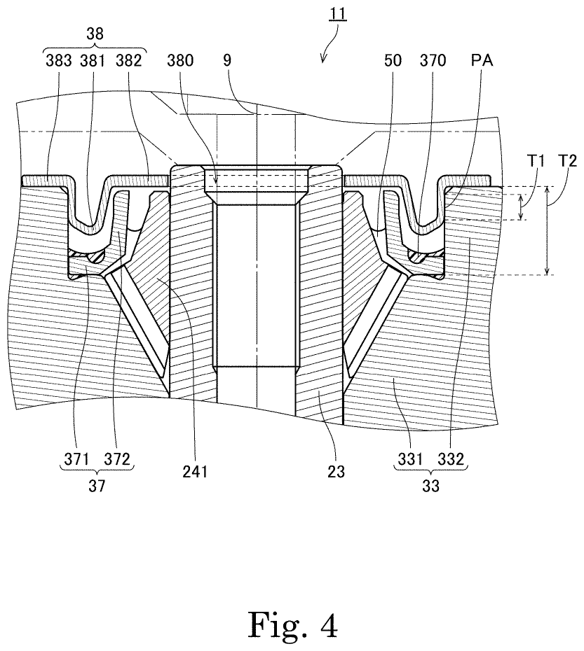

The outer ring 37 is a member disposed on the upper side of the sleeve main body 331 and in the radially inside of the sleeve projecting portion 332. A metal such as stainless steel is used as the material of the outer ring 37. The axial position of the upper end portion of the outer ring 37 is positioned lower than the axial position of the upper end portion of the shaft 23. The outer ring 37 has a first flat plate portion 371 and a first tubular portion 372. The first flat plate portion 371 and the first tubular portion 372 are formed integrally. The first flat plate portion 371 expands in an annular and flat plate shape along an upper surface of the sleeve main body 331. An outer circumferential portion of the first flat plate portion 371 is fixed to the inner circumferential surface of the sleeve projecting portion 332 via an adhesive agent 370 (see FIG. 4). That is, the first flat plate portion 371 radially inwardly extends from the inner circumferential surface of the sleeve projecting portion 332. A lower surface of the first flat plate portion 371 is in contact with the upper surface of the sleeve main body 331. The first tubular portion 372 extends axially in a tubular shape upwardly from the radially inner end portion of the first flat plate portion 371.

An inner circumferential surface of the first tubular portion 372 of the outer ring 37 and an outer circumferential surface of the upper portion of the first inner ring 241 face each other across a radial gap. By providing the outer ring 37, an interface of the lubricating oil 50 (upper lubricating oil) is formed in the radial gap between the inner circumferential surface of the first tubular portion 372 of the outer ring 37 and the outer circumferential surface of the upper portion of the first inner ring 241. The lubricating oil 50 positioned in the radially inside of the outer ring 37 is suppressed from spreading to the radially outside of the outer ring 37.

The first cap 38 is a member expanding annularly about the central axis 9 around the upper end portion of the shaft 23. A metal such as stainless steel is used as the material of the first cap 38. The first cap 38 covers an axially upper side of the first inner ring 241 and the outer ring 37. The structure of the first cap 38 will be described in detail later.

The second cap 39 is a member expanding annularly about the central axis 9 between the lower end portion of the sleeve main body 331 and the shaft 23. The axial position of the lower end portion of the second cap 39 is positioned higher than the axial position of the upper end portion of the base bottom plate portion 211. The second cap 39 has a second tubular portion 391 and a second flat plate portion 392. The second tubular portion 391 is fixed to the lower end portion of the sleeve main body 331 and extends axially downward in a tubular shape. The second flat plate portion 392 radially inwardly extends from the lower end portion of the second tubular portion 391. The inner circumferential surface of the second tubular portion 391 of the second cap 39 and the outer circumferential surface of the lower portion of the second inner ring 242 face each other across a radial gap. In addition, the second flat plate portion 392 has a through hole 390 (see FIG. 2) axially penetrating the second flat plate portion 392 in a part in the circumferential direction.

The structure of the bearing portion will be described later in detail.

When a drive current is supplied to the coil 42 via the above-described circuit board in the motor 11, a magnetic flux is generated in the plurality of teeth 412. Then, a circumferential torque is generated between the stationary portion 2 and the rotating portion 3 by an action of the magnetic flux between the teeth 412 and the magnet 36. As a result, the rotating portion 3 rotates about the central axis 9 with respect to the stationary portion 2. The magnetic disk 12 mounted on the hub 34 rotates about the central axis 9 together with the rotating portion 3.

### 1-3. Configuration of Bearing Portion

Next, the detailed configuration of the bearing portion will be described. In the following description, FIG. 1 to FIG. 3 will be used as references where appropriate.

As described above, the stationary portion 2 including the shaft 23, the first inner ring 241, and the second inner ring 242, and the rotating portion 3 including the sleeve 33, the outer ring 37, and the second cap 39 face each other across a gap. The lubricating oil 50 is interposed in the gap. A plurality of dynamic pressure grooves (not illustrated) are provided on at least one of the outer circumferential surface of the lower portion of the first inner ring 241 and the upper inclined surface 92 of the sleeve 33. A plurality of dynamic pressure grooves (not illustrated) are provided on at least one of the outer circumferential surface of the upper portion of the second inner ring 242 and the lower inclined surface 93 of the sleeve 33. When the motor 11 is rotating, fluid dynamic pressure is induced in the lubricating oil 50 by these dynamic pressure grooves (not illustrated). As a result, the rotating portion 3 rotates stably by being supported from the stationary portion 2. That is, in the present example embodiment, the bearing portion is constituted by the shaft 23, the first inner ring 241, and the second inner ring 242, which are members on the stationary portion 2 side, the sleeve 33, the outer ring 37, and the second cap 39, which are members on the rotating portion 3 side, the plurality of dynamic pressure grooves described above, and the lubricating oil 50 interposed in the gap.

A polyolester oil or a diester oil, for example, is used as the lubricating oil 50. The rotating portion 3 including the sleeve 33, the outer ring 37, and the second cap 39 rotates about the central axis 9 while being supported via the lubricating oil 50 with respect to the stationary portion 2 including the shaft 23, the first inner ring 241, and the second inner ring 242.

The lubricating oil 50 (upper lubricating oil) is continuously present in a gap between the outer circumferential surface of the upper portion of the first inner ring 241 and the inner circumferential surface of the first tubular portion 372 of the outer ring 37, a gap between the outer circumferential surface of the lower portion of the first inner ring 241 and the upper inclined surface 92 of the sleeve main body 331, and a gap between the outer circumferential surface of the shaft 23 and the upper portion of the inner circumferential surface 91 of the sleeve main body 331. Further, the lubricating oil 50 (lower lubricating oil) is continuously present in a gap between the outer circumferential surface of the shaft 23 and the lower portion of the inner circumferential surface 91 of the sleeve main body 331, a gap between the outer circumferential surface of the upper portion of the second inner ring 242 and the lower inclined surface 93 of the sleeve main body 331, and a gap between the outer circumferential surface of the lower portion of the second inner ring 242 and the inner circumferential surface of the second tubular portion 391 of the second cap 39. However, the gap between the outer circumferential surface of the shaft 23 and a vicinity of the axial center of the inner circumferential surface 91 of the sleeve main body 331 is a space (oil-free space 500) in which the lubricating oil 50 is not present.

That is, in the present example embodiment, the bearing portion has a so-called partial fill structure in which the lubricating oil 50 is present in two or more places in a gap where the stationary portion 2 and the rotating portion 3 face each other. The lubricating oil 50 includes an upper lubricating oil present higher than the axially central portion of the sleeve main body 331 and a lower lubricating oil present lower than the axially central portion of the sleeve main body 331.

However, the lubricating oil 50 may be continuously present in a gap between the outer circumferential surface of the upper portion of the first inner ring 241 and the inner circumferential surface of the first tubular portion 372 of the outer ring 37, a gap between the outer circumferential surface of the lower portion of the first inner ring 241 and the upper inclined surface 92 of the sleeve main body 331, a gap between the outer circumferential surface of the shaft 23 and the inner circumferential surface 91 of the sleeve main body 331, a gap between the outer circumferential surface of the upper portion of the second inner ring 242 and the lower inclined surface 93 of the sleeve main body 331, and a gap between the outer circumferential surface of the lower portion of the second inner ring 242 and the inner circumferential surface of the second tubular portion 391 of the second cap 39. That is, the bearing portion may have a so-called full fill structure in which the lubricating oil 50 is continuously present in the gap where the stationary portion 2 and the rotating portion 3 face each other. This can suppress contact between the stationary portion 2 and the rotating portion 3 even in a case where an impact is applied during rotation of the motor 11.

At the time of manufacturing the motor 11, the stationary portion 2 including the shaft 23, the first inner ring 241, and the second inner ring 242 and the rotating portion 3 including the sleeve 33, the outer ring 37, and the second cap 39 are first assembled. At this time, in a state where the first cap 38 is not attached to the sleeve 33, the outer ring 37 is fixed to the inner circumferential surface of the sleeve projecting portion 332 via the adhesive agent 370. Then, the lubricating oil 50 (upper lubricating oil) is poured downward from the gap between the outer circumferential surface of the upper portion of the first inner ring 241 and the inner circumferential surface of the first tubular portion 372 of the outer ring 37. At this time, the gap between the first inner ring 241 and the outer ring 37 opens upward over the entire circumference about the central axis 9. Therefore, it is possible to highly accurately and easily pour the lubricating oil 50 from any circumferential position. In addition, since the operation of circumferentially positioning the opening for pouring the lubricating oil 50 becomes unnecessary, the manufacturing cost can be reduced. After pouring the upper lubricating oil, an upper interface (at least one of the interfaces of the upper lubricating oil) of the upper lubricating oil is positioned in the radial gap between the first inner ring 241 and the outer ring 37.

In the case of having the partial fill structure, after the upper lubricating oil is poured, the lubricating oil 50 (lower lubricating oil) is further poured upward from the through hole 390 of the second cap 39. After pouring the lower lubricating oil, a lower interface (at least one of the interfaces of the lower lubricating oil) of the lower lubricating oil is positioned in the radial gap between the second inner ring 242 and the second tubular portion 391 of the second cap 39.

Further, in the case of having the partial fill structure, the air in the oil-free space 500 communicates with the external space via the first communication hole 232, the hollow portion 231, the second communication hole 233, and the gap 600. As a result, the pressure in the vicinity of the upper and lower interfaces of the upper lubricating oil and the pressure in the vicinity of the upper and lower interfaces of the lower lubricating oil become substantially equal. Therefore, it is possible to suppress movement and leakage of each of the upper lubricating oil and the lower lubricating oil attributable to the pressure difference in the vicinity of the upper and lower interfaces.

As described above, the disk drive device 1 of the present example embodiment is a device that reads and writes information from and to the magnetic disk 12 while rotating the magnetic disk 12. The rotating portion 3 of the motor 11 supporting the magnetic disk 12 is rotatably supported via the bearing portion that is a fluid dynamic pressure bearing. As a result, vibration generated from the motor 11 during driving of the disk drive device 1 is less likely to be transmitted to the magnetic disk 12. Therefore, the stability and the accuracy of rotation of the magnetic disk 12 are improved by suppressing the vibration of the magnetic disk 12. As a result, it is possible to highly accurately read and write information from and to the magnetic disk 12.

### 1-4. Configuration of First Cap

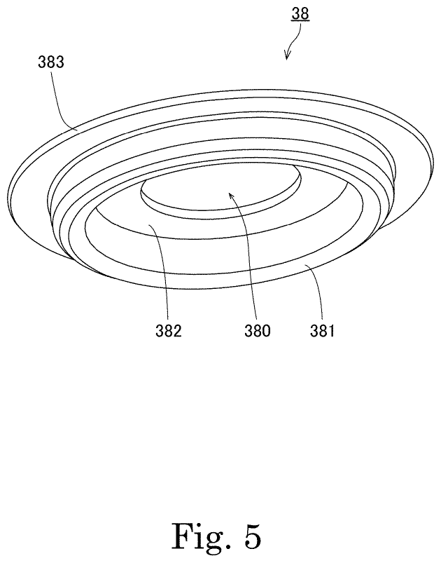

Subsequently, a more detailed configuration of the first cap 38 will be described. FIG. 4 is a partial longitudinal sectional view of the motor 11 according to the first example embodiment. FIG. 5 is a perspective view of the first cap 38 according to the first example embodiment. In the following description, FIG. 1 to FIG. 5 will be used as references where appropriate.

As shown in FIG. 4, the first cap 38 is a member expanding annularly about the central axis 9 around the shaft 23. The first cap 38 has a recess portion 381, a cap inner disk portion 382, and a cap outer disk portion 383. The recess portion 381 is a portion recessed axially downward over the entire circumference of the first cap 38. The cap inner disk portion 382 is a portion radially inwardly expanding from an upper end portion of a radially inner portion of the recess portion 381. The cap outer disk portion 383 is a portion radially outwardly expanding from an upper end portion of a radially outer portion of the recess portion 381. The first cap 38 has a through hole 380 in the center. The through hole 380 axially penetrates the first cap 38.

At the time of manufacturing the motor 11, the first cap is attached after the lubricating oil 50 (upper lubricating oil) is poured between the stationary portion 2 including the shaft and the first inner ring 241 and the rotating portion 3 including the sleeve 33 and the outer ring 37. The first cap 38 is disposed around the shaft 23 so as to cover the axial upper side of the first inner ring 241 and the outer ring 37. More specifically, the first cap 38 is inserted downward so that at least a part of the recess portion 381 of the first cap 38 is positioned radially between the first tubular portion 372 of the outer ring 37 and the sleeve projecting portion 332. At this time, the upper end portion of the shaft 23 is caused to pass through the through hole 380 of the first cap 38. At least a part of the outer circumferential surface of the recess portion 381 is fixed by press-fitting to the inner circumferential surface of the sleeve projecting portion 332. Further, the lower surface of the cap outer disk portion 383 comes into contact with at least a part of the upper surface of the sleeve projecting portion 332. As a result, while being axially positioned, the first cap 38 is supported by the rotating portion 3 including the sleeve projecting portion 332. Further, the cap inner disk portion 382 covers the upper part of the interface of the lubricating oil 50 (upper lubricating oil) positioned in the radial gap between the first inner ring 241 and the outer ring 37. As a result, evaporation of the lubricating oil 50 (upper lubricating oil) is suppressed.

Further, as described above, by including the recess portion 381, the first cap 38 is easily bent in the radial direction. In particular, in the present example embodiment, since the vicinity of the portion of the recess portion 381 that is in contact with the sleeve projecting portion 332 is bent at an obtuse angle, it is easily bent in the radial direction, compared with the case where the vicinity of the portion is bent at an acute angle. For this reason, when the recess portion 381 of the first cap 38 is press-fitted to the inner circumferential surface of the sleeve projecting portion 332, stress generated in the sleeve 33 including the sleeve projecting portion 332 is suppressed. As a result, the sleeve 33 and the hub 34, fixed to the outer circumferential surface of the sleeve 33, are suppressed from rotating eccentrically or inclined relative to the central axis. As a result, the stability and the accuracy of rotation of the magnetic disk 12 supported by the hub 34 are improved. In addition, cracking of the adhesive agent 370 between the sleeve 33 and the outer ring 37 is suppressed. As a result, the lubricating oil 50 positioned in the radially inside of the outer ring 37 is suppressed from leaking (oil leak) to the radially outside of the outer ring 37.

In the present example embodiment, an axial length T1 of a press-fit region PA, which is the region of the inner circumferential surface of the sleeve projecting portion 332 to which the recess portion 381 is press-fitted, is larger than a quarter of an axial length T2 of the sleeve projecting portion 332 and is smaller than a half of the axial length T2 of the sleeve projecting portion 332. In this way, by ensuring a sufficient axial length of the press-fit region PA, the first cap 38 is suppressed from coming off and scattering when the motor 11 is driven. In addition, since the axial length of the press-fit region PA does not become excessively large, the lower end portion of the recess portion 381 is suppressed from coming into contact with the first flat plate portion 371 of the outer ring 37. In addition, when the recess portion 381 is press-fitted to the inner circumferential surface of the sleeve projecting portion 332, stress generated in the sleeve 33 is further suppressed. As a result, the stability and the accuracy of rotation of the magnetic disk 12 are further improved. In addition, cracking of the adhesive agent 370 between the sleeve 33 and the outer ring 37 is further suppressed.

Further, in the present example embodiment, the axial position of the lower end portion of the press-fit region PA is positioned higher than the axial position of the lower end portion of the recess portion 381. As a result, the first cap 38 is further easily bent in the radial direction. Accordingly, when the recess portion 381 is press-fitted to the inner circumferential surface of the sleeve projecting portion 332, stress generated in the sleeve 33 is further suppressed. As a result, the stability and the accuracy of rotation of the magnetic disk 12 are further improved and cracking of the adhesive agent 370 between the sleeve 33 and the outer ring 37 is further suppressed. Further, since the first cap 38 is further easily bent in the radial direction, deformation and breakage of the first cap 38 itself are further suppressed when the recess portion 381 is press-fitted to the inner circumferential surface of the sleeve projecting portion 332.

### 2. Modification

While the exemplary example embodiment of the present disclosure has been described above, the present disclosure is not limited to the example embodiment described above.

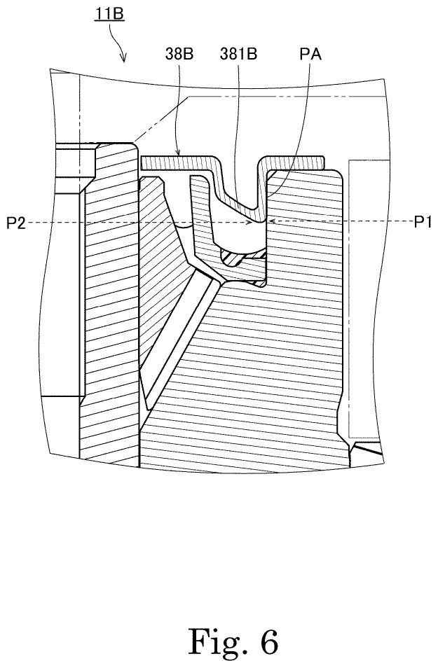

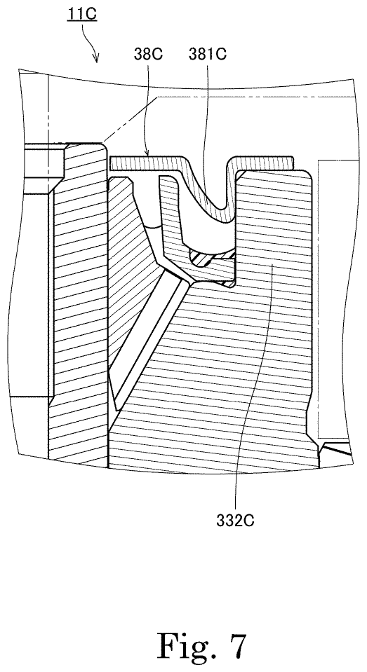

First, the shape of the first cap including the recess portion is not limited to the above-described example embodiment. FIG. 6 is a partial longitudinal sectional view of a motor 11B according to a modification. As shown in the modification of FIG. 6, an axial position P1 of a lower end portion of the press-fit region PA and an axial position P2 of a lower end portion of a recess portion 381B of a first cap 38B may be equal to each other. FIG. 7 is a partial longitudinal sectional view of a motor 11C according to a modification. As shown in the modification of FIG. 7, a first cap 38C including a recess portion 381C may have a shape that is easily bent in the radial direction when press-fitted to the inner circumferential surface of a sleeve projecting portion 332C, and it may be different from the shape shown in FIG. 5 and FIG. 6.

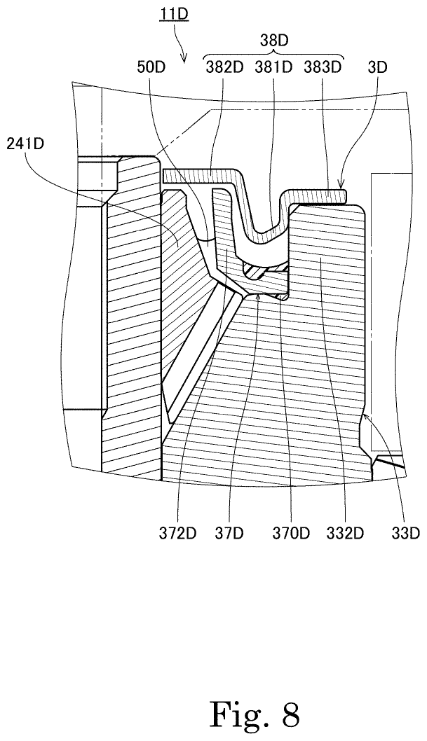

FIG. 8 is a partial longitudinal sectional view of a motor 11D according to another modification. In the example of FIG. 8, the axial position of an upper surface of a sleeve projecting portion 332D is positioned lower than the axial position of an upper surface of a first tubular portion 372D of an outer ring 37D. The axial position of a lower surface of a cap outer disk portion 383D of a first cap 38D is positioned lower than the axial position of a lower surface of a cap inner disk portion 382D. That is, the press-fit area of the first cap 38D and the sleeve projecting portion 332D is smaller than the press-fit area of the first cap and the sleeve projecting portion in the above-described example embodiment and modifications. As a result, when the first cap 38D is press-fitted to the sleeve projecting portion 332D, stress generated in the sleeve projecting portion 332D is reduced. Also, when a recess portion 381D of the first cap 38D is press-fitted to an inner circumferential surface of the sleeve projecting portion 332D, the lower surface of the cap outer disk portion 383D comes into contact with the upper surface of the sleeve projecting portion 332D. As a result, while being axially positioned, the first cap 38D is supported by a rotating portion 3D including the sleeve projecting part 332D. Then, the recess portion 381D of the first cap 38D is bent in the radial direction, thereby further suppressing the stress generated in a sleeve 33D including the sleeve projecting portion 332D. As a result, the stability and the accuracy of rotation of the magnetic disk indirectly supported from the sleeve 33D are further improved, and cracking of an adhesive agent 370D between the sleeve 33D and the outer ring 37D is further suppressed. In addition, the cap inner disk portion 382D covers an upper part of an interface of a lubricating oil 50D (upper lubricating oil) positioned in a radial gap between a first inner ring 241D and the outer ring 37D. As a result, evaporation of the lubricating oil 50D (upper lubricating oil) is suppressed.

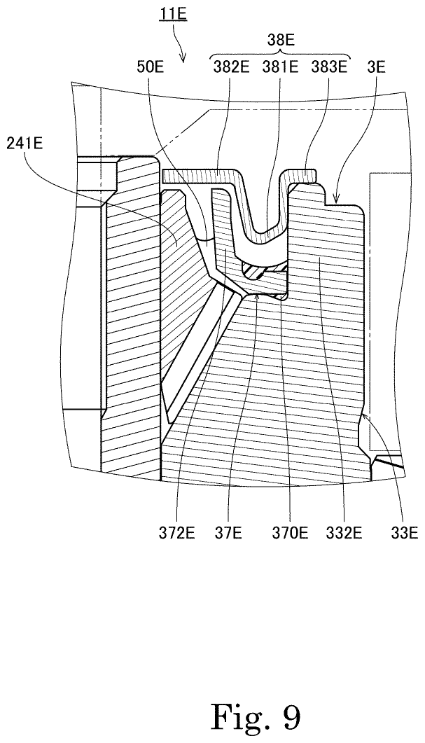

FIG. 9 is a partial longitudinal sectional view of a motor 11E according to another modification. In the example of FIG. 9, the axial position of a part including a radially outer end portion of an upper surface of a sleeve projecting portion 332E is positioned lower than the axial position of a part including a radially inner end portion of the upper surface of the sleeve projecting portion 332E. More specifically, the axial position of the part including the radially inner end portion of the upper surface of the sleeve projecting portion 332E is the same as the axial position of an upper surface of a first tubular portion 372E of an outer ring 37E. On the other hand, the axial position of the part including the radially outer end portion of the upper surface of the sleeve projecting portion 332E is positioned lower than the axial position of the upper surface of the first tubular portion 372E of the outer ring 37E. The radial length of a cap outer disk portion 383E of a first cap 38E is shorter than the radial length of the cap outer disk portion 383E in the above-described example embodiment and modifications. When a recess portion 381E of the first cap 38E is press-fitted to an inner circumferential surface of the sleeve projecting portion 332E, a lower surface of the cap outer disk portion 383E comes into contact with a part including a radially inner end portion of an upper surface of the sleeve projecting portion 332E. As a result, while being axially positioned, the first cap 38E is supported by a rotating portion 3E including the sleeve projecting portion 332E. Then, the recess portion 381E of the first cap 38E is bent in the radial direction, thereby suppressing stress generated in a sleeve 33E including the sleeve projecting portion 332E. Furthermore, in the present modification, stress and bend generated in the sleeve 33E can be concentrated on a part including a radially inner end portion of the sleeve projecting portion 332E. That is, stress and bend are unlikely to be generated in the part including the radially outer end portion of the sleeve projecting portion 332E. This improves the stability and the accuracy of rotation of the magnetic disk indirectly supported from a part including a radially outer end portion of the sleeve 33E where stress and bend hardly occur, and suppresses cracking of an adhesive agent 370E between the sleeve 33E and the outer ring 37E. In addition, the cap inner disk portion 382E covers an upper part of an interface of a lubricating oil 50E (upper lubricating oil) positioned in a radial gap between a first inner ring 241E and the outer ring 37E. As a result, evaporation of the lubricating oil 50E (upper lubricating oil) is suppressed.

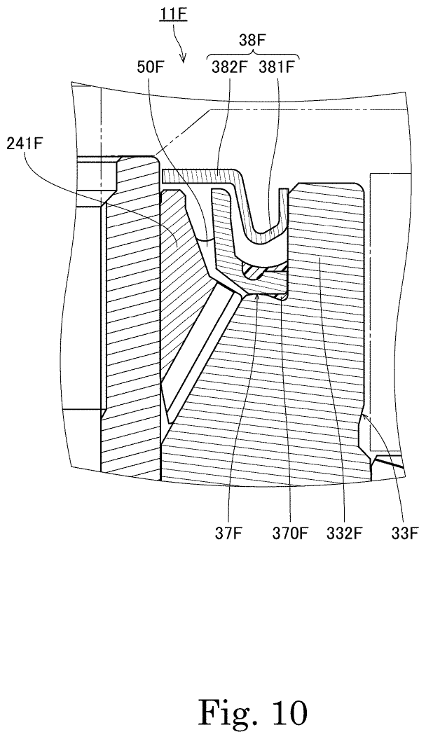

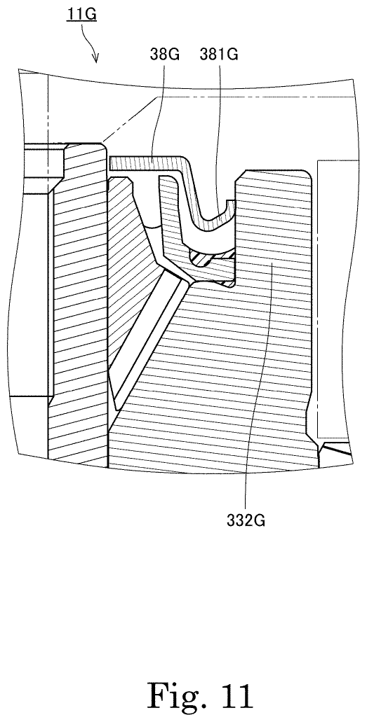

FIG. 10 is a partial longitudinal sectional view of a motor 11F according to another modification. In the example of FIG. 10, a first cap 38F has a recess portion 381F and a cap inner disk portion 382F. When the recess portion 381F of the first cap 38F is press-fitted to an inner circumferential surface of a sleeve projecting portion 332F, an radially outer end portion of the first cap 38F is positioned radially inward than a sleeve projecting portion 332F. That is, an equivalent of the cap outer disk portion in the above-described example embodiment and modifications is not present. Then, the recess portion 381F of the first cap 38F is bent in the radial direction, thereby suppressing stress generated in a sleeve 33F including the sleeve projecting portion 332F. This improves the stability and the accuracy of rotation of the magnetic disk indirectly supported from the sleeve 33F, and suppresses cracking of an adhesive agent 370F between the sleeve 33F and an outer ring 37F. In addition, the cap inner disk portion 382F covers an upper part of an interface of a lubricating oil 50F (upper lubricating oil) positioned in a radial gap between a first inner ring 241F and the outer ring 37F. As a result, evaporation of the lubricating oil 50F (upper lubricating oil) is suppressed. Further, as shown in the modification of FIG. 11, as compared to the modification shown in FIG. 10, an upper end portion of a portion of the radially outside of a first cap 38G including a recess portion 381G may be positioned further lower than an upper end portion of a portion of the radially inside of a sleeve projecting portion 332G.

In the example embodiment and the modifications described above, the periphery of the upper portion of the shaft is provided with the outer ring forming the interface of the lubricating oil in the radial gap with the first inner ring and the first cap covering the upper part of the lubricating oil. On the other hand, in the periphery of the lower portion of the shaft, the second cap forms the interface of the lubricating oil and serves to cover the lower part of the lubricating oil. However, the periphery of the lower portion of the shaft may also be provided with a member forming the interface of the lubricating oil in the radial gap with the second inner ring and a member covering the lower part of the lubricating oil.

In place of the magnetic disk of the present disclosure, an impeller or a flywheel may be used. Also, the motor of the present disclosure may be used as a fan motor that supplies air flow.

It is to be noted that the shape of details of the motor may be different from the structure and the shape presented in each of the drawings of the present application. In addition, each of the elements appearing in the above-described example embodiment and modifications may also be appropriately combined in a range where no conflict occurs.

The present disclosure is applicable to motors and disk drive devices.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a stationary portion including a stator;
a rotating portion rotatably supported via a bearing portion about a vertically extending central axis with respect to the stationary portion;
a shaft disposed along the central axis;
an inner ring fixed on an outer circumferential surface of the shaft;
a tubular sleeve extending axially around the shaft;
an outer ring fixed to an inner circumferential surface of the sleeve;
a cap annularly expanding around the shaft and covering an axially upper side of the inner ring and the outer ring; and
the bearing portion including a plurality of dynamic pressure grooves in at least one of an outer circumferential surface of the inner ring and the inner circumferential surface of the sleeve; wherein
in the bearing portion, the stationary portion and the rotating portion face each other across a gap where lubricating oil is present;
at least one interface of the lubricating oil is positioned in a radial gap between the inner ring and the outer ring;
the cap includes a recess portion recessed axially downward over an entire circumference; and
at least a portion of an outer circumferential surface of the recess portion is press-fitted to the inner circumferential surface of the sleeve.

2. The motor according to claim 1, wherein the outer ring includes:
a flat plate portion radially inwardly extending from the inner circumferential surface of the sleeve;
a tubular portion axially upwardly extending from a radially inner end portion of the flat plate portion; and
at least a portion of the recess portion is positioned radially between the tubular portion and the sleeve.

3. The motor according to claim 1, wherein a lower end portion of a press-fit region, which is a region into which the recess portion is press-fitted, of the inner circumferential surface of the sleeve is positioned axially higher than a lower end portion of the recess portion.

4. The motor according to claim 1, wherein an axial position of a lower end portion of a press-fit region, which is a region into which the recess portion is press-fitted, of the inner circumferential surface of the sleeve and an axial position of a lower end portion of the recess portion are equal to each other.

5. The motor according to claim 1, wherein the sleeve includes:
a tubular sleeve main body extending axially around the shaft and in which the lubricating oil is in contact with an inner circumferential surface; and
a sleeve projecting portion projecting upward from an upper portion of the sleeve main body radially outside of the outer ring and in which the lubricating oil is not in contact with an inner circumferential surface;
the outer ring is fixed to the inner circumferential surface of the sleeve projecting portion; and
at least a portion of an outer circumferential surface of the recess portion is press-fitted to the inner circumferential surface of the sleeve projecting portion.

6. The motor according to claim 5, wherein an axial length of a press-fit region, which is a region into which the recess portion is press-fitted, of the inner circumferential surface of the sleeve is larger than a quarter of an axial length of the sleeve projecting portion and is smaller than a half of the axial length of the sleeve projecting portion.

7. The motor according to claim 5, wherein
the cap further includes a cap outer disk portion radially outwardly expanding from an upper end portion of a portion of a radially outside of the recess portion; and
the cap outer disk portion is in contact with at least a portion of an upper surface of the sleeve projecting portion.

8. The motor according to claim 7, wherein the upper surface of the sleeve projecting portion is positioned lower than an upper surface of the outer ring.

9. The motor according to claim 7, wherein
a radially outer end portion of the upper surface of the sleeve projecting portion is positioned lower than a radially inner end portion of the upper surface of the sleeve projecting portion; and
the cap outer disk portion is in contact with a portion including the radially inner end portion of the upper surface of the sleeve projecting portion.

10. The motor according to claim 5, wherein a radially outer end portion of the cap is positioned farther radially inward than the sleeve projecting portion.

11. The motor according to claim 10, wherein an upper end portion of a portion of a radially outside of the cap is positioned lower than an upper end portion of a portion of a radially inside of the sleeve projecting portion.

12. A disk drive device comprising:
the motor according to claim 1;
an access portion to perform at least one of reading and writing information from and to a disk supported by the rotating portion of the motor; and
a cover; wherein
the stationary portion includes a base portion directly or indirectly supporting the stator; and
the rotating portion and the access portion are accommodated in a casing defined by the base portion and the cover.
